(19) United States
(12) Patent Application Publication
(10) Pub. No.: US 2012/0146336 A1
(43) Pub. Date: Jun. 14, 2012

(54) PERMANENT MAGNET ROTATING ELECTRICAL MACHINE AND METHOD FOR MANUFACTURING A ROTOR OF THE SAME

(76) Inventors: Masahiro HORI, Hitachiomiya (JP); Mamoru Kimura, Hitachinaka (JP); Akiyoshi Komura, Hitachi (JP); Takayuki Koizumi, Hitachinaka (JP); Masayasu Fujieda, Hitachi (JP); Seikichi Masuda, Hitachi (JP); Nobuhiko Obata, Hitachi (JP)

(21) Appl. No.: 13/314,222

(22) Filed: Dec. 8, 2011

(30) Foreign Application Priority Data
Dec. 8, 2010 (JP) 2010-273121

(51) Int. Cl. H02K 1/27; H02K 15/03; F03D 9/00; H02K 1/04; H02K 1/32

(52) U.S. Cl. 290/55; 310/156.12; 310/43; 310/59; 29/598; 903/906

(57) ABSTRACT

A permanent magnet rotating electrical machine comprises a stator with a stator coil applied in a plurality of slots provided in a stator core, a rotor disposed opposite to the stator with a predetermined gap interposed therebetween, the rotor including a permanent magnet embedded in each of magnet-insertion holes provided in a rotor core of the rotor while polarity of the permanent magnet being varied on a pole-by-pole basis, and end plates disposed at ends of the rotor core, in the axial direction thereof, respectively, in which one end plate of the end plates disposed at the ends of the rotor core, in the axial direction thereof, respectively, is also provided with magnet-insertion holes, and each of the magnet-insertion holes provided in the one endplate is filled up with a non-magnetic material, thereby stopping up each of the magnet-insertion holes provided in the end plate.

### CLAIM OF PRIORITY

The present application claims priority from Japanese patent application serial no. 2010-273121, filed on Dec. 8, 2010, the content of which is hereby incorporated by reference into this application.

### FIELD OF THE INVENTION

The present invention relates to a permanent magnet rotating electrical machine, and a method for manufacturing a rotor of the same, and in particular, to a permanent magnet rotating electrical machine mounted in a wind turbine generator, or a rail car, suitable for use as one with a magnetized permanent magnet embedded in a rotor core, and a method for manufacturing a rotor of the same.

### BACKGROUND OF THE INVENTION

As progress has lately been made in miniaturization, and higher efficiency of rotating electrical machines, a permanent magnet rotating electrical machine has come to be used in a variety of fields.

Problems with application of a permanent magnet include manufacturing of a rotor. In the case of a rotating electrical machine in a several MW output class, such as a rail car generator, a wind turbine generator, and so forth, in particular, if an attempt is made to cause a magnet to be magnetized after formation of a rotor (a state in which a rotor core, and end plates are fixed to a rotating shaft), a magnetization device for use in magnetization will increase in size, so that it is considered more appropriate to manufacture a rotating electrical machine by use of a magnetized permanent magnet.

However, if an attempt is made to insert a magnetized permanent magnet into the rotor core at the time of manufacturing a rotor using a magnetized permanent magnet, there is a possibility that magnetic steel sheets making up the rotor core will come apart by the agency of an attractive force of the magnetized permanent magnet, thereby raising a risk that it becomes difficult to secure laminated magnetic steel sheets. Further, it is known that the characteristics of a permanent magnet undergo deterioration at a high temperature due to irreversible degaussing, and if the rotor core is fixed to the rotating shaft by shrinkage fit, this will cause the permanent magnet to be at high temperature, rendering it impossible to adopt the shrinkage fit for fixing of the rotor core to the rotating shaft.

Accordingly, in Japanese Unexamined Patent Application Publication No. 2010-142038, as a conventional technology, there is described a method for inserting a magnetized permanent magnet into a rotor core after formation of a rotor.

In Japanese Unexamined Patent Application Publication No. 2010-142038, it is described that an end plate is formed of a resin material, thereby rendering it possible to insert a permanent magnet into a rotor core after formation of a rotor, and further, to aim at reduction in weight, and enhancement in production efficiency.

However, if the end plate is formed of the resin material as described in Patent Document 1, this will cause the resin material to undergo deterioration in strength due to aging degradation, thereby raising a problem in that, in case the permanent magnet is broken, it will be impossible to prevent the permanent magnet from popping out, so that long-term reliability cannot be ensured.

The present invention has been developed in view of the problem described as above, and it is an object of the invention to provide a permanent magnet rotating electrical machine capable of preventing a magnetized permanent magnet from popping out even though the magnetized permanent magnet is inserted after a rotor is formed, thereby ensuring long-term reliability, and a method for manufacturing a rotor of the same.

### SUMMARY OF THE INVENTION

In order to attain the object of the invention, the invention provides in its one aspect a permanent magnet rotating electrical machine comprising a stator provided with a stator coil applied in a plurality of slots provided in a stator core, respectively, and a rotor disposed opposite to the stator with a predetermined gap interposed therebetween, the rotor including a permanent magnet embedded in each of magnet-insertion holes provided in a rotor core of the rotor while polarity of the permanent magnet being varied on a pole-by-pole basis, and end plates disposed at ends of the rotor core, in the axial direction thereof, respectively, wherein one end plate of the end plates disposed at the ends of the rotor core, in the axial direction thereof, respectively, is provided with magnet-insertion holes, and each of the magnet-insertion holes provided in the one end plate is filled up with a non-magnetic material, thereby stopping up the magnet-insertion holes.

Further, in order to attain another object of the invention, the invention provides in its another aspect a method for manufacturing a rotor of a permanent magnet rotating electrical machine, comprising the steps of laminating a plurality of magnetic steel sheets in the axial direction of the rotor, thereby forming a rotor core with magnet-insertion holes provided therein, disposing one end plate with magnet-insertion holes formed therein, at one end of the rotor core, in the axial direction thereof while disposing the other end plate without the magnet-insertion hole formed therein, at the other end of the rotor core, in the axial direction thereof, inserting a magnetized permanent magnet into each of the magnet-insertion holes of the rotor core via each of the magnet-insertion holes provided in the end plate after fixedly attaching the rotor core, and both of the end plates to a rotating shaft, and filling up each of the magnet-insertion holes provided in the end plate with a non-magnetic material after the magnetized permanent magnet is inserted, thereby stopping up each of the magnet-insertion holes provided in the end plate. With the permanent magnet rotating electrical machine according to the invention, it is possible to prevent a magnetized permanent magnet from popping out even though the magnetized permanent magnet is inserted after a rotor is formed, so that the invention can provide a permanent magnet rotating electrical machine with its long-term reliability ensured.

### BRIEF DESCRIPTION OF THE DRAWINGS

FIG. 1 is a sectional view showing a first embodiment of a permanent magnet rotating electrical machine according to the invention, in the radial direction thereof (a first embodiment);

FIG. 2 is a sectional view showing a rotor of FIG. 1, in section, in the axial direction thereof (the first embodiment);

FIG. 3A is a perspective view showing one of end plates adopted by the first embodiment of the permanent magnet rotating electrical machine according to the invention (the first embodiment);

FIG. 3B is a perspective view showing the other of the end plates adopted by the first embodiment of the permanent magnet rotating electrical machine according to the invention (the first embodiment);

FIG. 4 is a perspective view of the rotor before a magnetized permanent magnet is inserted into each of magnet-insertion holes of a rotor core, showing one embodiment of a method for manufacturing the permanent magnet rotating electrical machine according to the invention (the first embodiment);

FIG. 5 is a perspective view of the rotor in a state in which each of the magnet-insertion holes provided in the one end plate is filled up with a non-magnetic material after the magnetized permanent magnet is inserted into each of magnet-insertion holes of the rotor core, showing the one embodiment of the method for manufacturing the permanent magnet rotating electrical machine according to the invention (the first embodiment);

FIG. 6 is a perspective view of the rotor in a state in which the non-magnetic material is inserted into each of the magnet-insertion holes of the one end plate, respectively, after the magnetized permanent magnet is inserted into each of magnet-insertion holes of the rotor core to thereby cover the magnet-insertion holes of the one end plate with a closing plate, showing the one embodiment of the method for manufacturing the permanent magnet rotating electrical machine according to the invention (the first embodiment);

FIG. 7 is a perspective view of the rotor before permanent magnets formed by splitting the permanent magnet in the axial direction of the rotor core are inserted into each of the magnet-insertion holes of the rotor core, showing another embodiment of a method for manufacturing the permanent magnet rotating electrical machine according to the invention (a second embodiment);

FIG. 8 is a perspective view of permanent magnets formed by splitting the permanent magnet in a crosswise direction of the rotor core, as well, adopted by the second embodiment of a method for manufacturing the permanent magnet rotating electrical machine according to the invention;

FIG. 9 is a perspective view of a rotor, showing a third embodiment of a method for manufacturing the permanent magnet rotating electrical machine according to the invention (the third embodiment);

FIG. 10 is a perspective view of a rotor, showing a fourth embodiment of a method for manufacturing the permanent magnet rotating electrical machine according to the invention (the fourth embodiment);

FIG. 11 is a sectional view showing the permanent magnet rotating electrical machine according to the fourth embodiment of the invention, in section, in the axial direction thereof (the fourth embodiment);

FIG. 12 is a sectional view showing the permanent magnet rotating electrical machine according to the fourth embodiment of the invention, in section, in the axial direction thereof, in the case where the permanent magnet rotating electrical machine shown in FIG. 11 has a cantilevered structure (the fourth embodiment);

FIG. 13A is a sectional view showing a permanent magnet rotating electrical machine according to a fifth embodiment of the invention, in section, in the radial direction of a rotor (the fifth embodiment);

FIG. 13B is a sectional view showing the permanent magnet rotating electrical machine according to the fifth embodiment of the invention, in section, in the axial direction of a rotor (the fifth embodiment);

FIG. 14 is a block diagram showing an example in which the permanent magnet rotating electrical machine according to the invention is applied to a hybrid-drive rail car system (a sixth embodiment); and

FIG. 15 is a block diagram showing an example in which the permanent magnet rotating electrical machine according to the invention is applied to a wind turbine system (a seventh embodiment).

### DETAILED DESCRIPTION OF THE PREFERRED EMBODIMENTS

There is described in detail hereinafter a permanent magnet rotating electrical machine on the basis of embodiments of the invention with reference to the accompanied drawings. In respective figures, identical parts are described by use of like reference numerals.

### First Embodiment

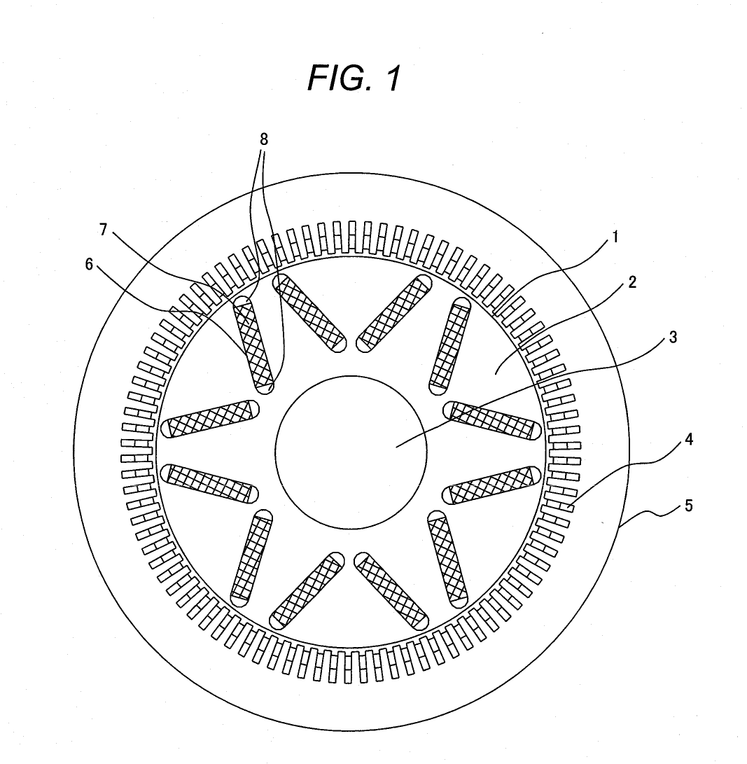

FIG. 1 shows a first embodiment of a permanent magnet rotating electrical machine according to the invention, and the permanent magnet rotating electrical machine is operated at a rotational speed in a range of 500 to 2000 min⁻¹ for several MW output.

As shown in the figure, a rotating shaft 3 is fixedly attached to a rotor core 2 of a rotor 1, and the rotor 1 is disposed opposite to a stator 5 with a predetermined gap interposed therebetween, the stator 5 including a stator coil 4 applied in a plurality of slots provided in a stator core, respectively, by distributed winding, and lap winding. The rotor core 2 is provided with a plurality of magnet-insertion holes 6, each of the magnet-insertion holes 6 being for use in insertion of a permanent magnet 7, and the permanent magnet 7 is embedded in each of the magnet-insertion holes 6. As to the plurality of magnet-insertion holes 6, two pieces of the magnet-insertion holes 6, making up a pair, are formed in a shape resembling the letter V, as seen in cross section, and plural pairs thereof are disposed in the circumferential direction of the rotor core 2, and are extended in a straight line in the axial direction thereof, the permanent magnet 7 being inserted in each of these magnet-insertion holes 6 to be disposed therein.

In order to enable the permanent magnet 7 to be inserted into the magnet-insertion hole 6, the magnet-insertion hole 6 is formed to be larger in size than the permanent magnet 7. Further, respective ends 8 of the magnet-insertion hole 6 need not be similar in shape to respective ends of the permanent magnet 7. In FIG. 1, the end 8 of the magnet-insertion hole 6 for insertion of the permanent magnet 7 is formed in the shape of, for example, an arc, as seen in cross-section. By so doing, it is possible to realize reduction in leakage fluxes as well as the peak stress to the permanent magnet 7.

Further, the end 8 of the magnet-insertion hole 6, in cross section, may be substantially in a triangle-like shape, or a shape in parallel with the outside diameter of the rotor.

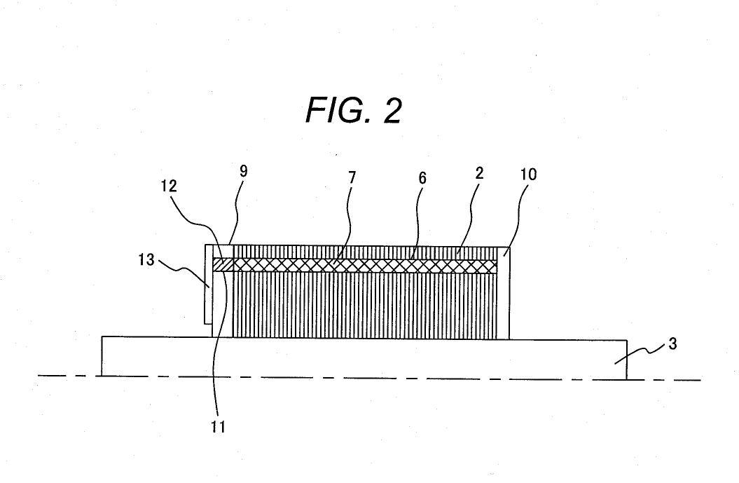

FIG. 2 is a view showing the rotor 1, in section, in the axial direction thereof. As shown in the figure, the rotor core 2 is made up by laminating plural sheets of magnetic steel sheets with each other, and end plates 9, 10 are disposed at ends of the rotor core 2, in the axial direction thereof, respectively. If the end plates 9, 10 are disposed at the ends of the rotor core 2, in the axial direction thereof, respectively, this will enable the laminated magnetic steel sheets to be secured, and the magnetic steel sheets to be prevented from undergoing deformation in the axial direction of the rotor core 2, so that the rotor core 2 can be prevented from becoming crimped, or buckling.

Further, the end plates 9, 10 disposed at the ends of the rotor core 2, respectively, differ in shape from each other.

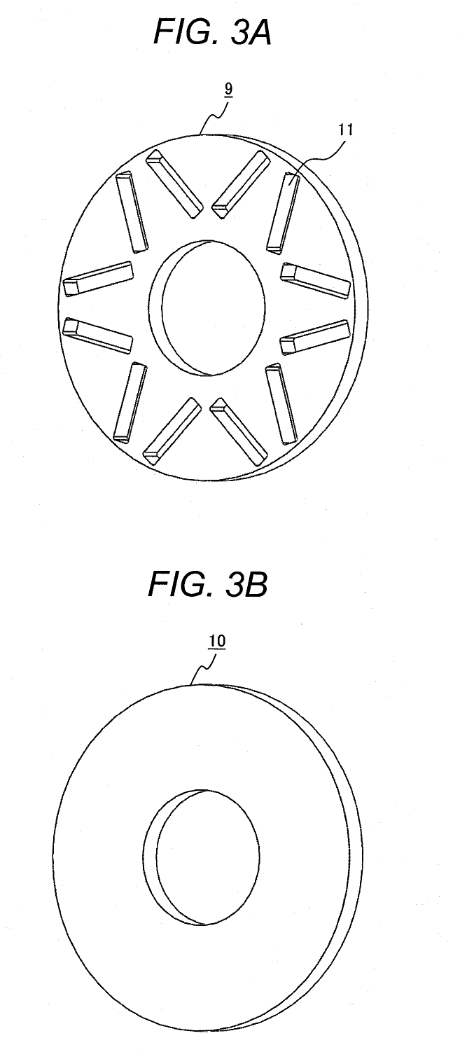

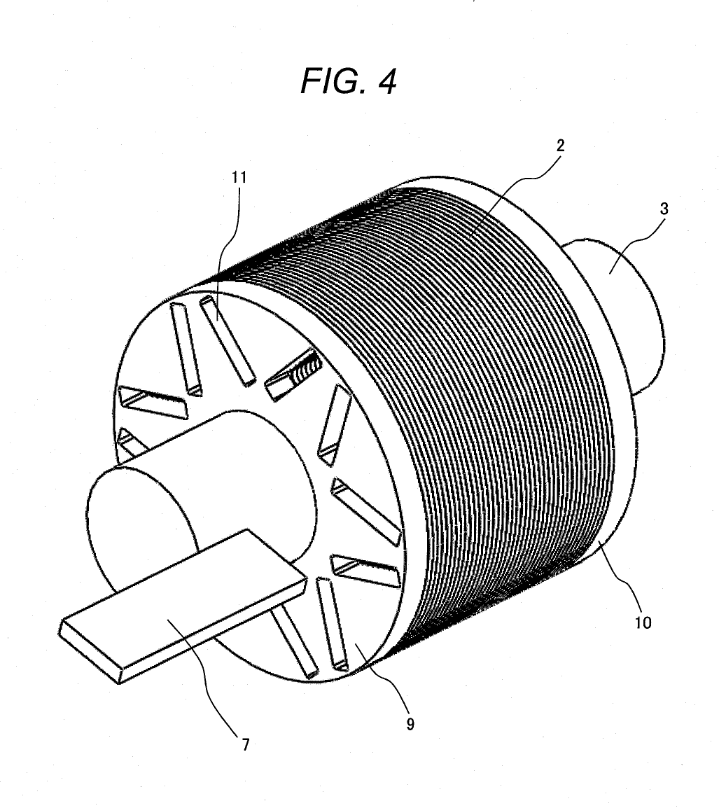

The end plates 9, 10 are shown in FIGS. 3A, and 3B, respectively. As is evident from in FIGS. 3A, and 3B, the end plate 9 is provided with magnet-insertion holes 11, however, the end plate 10 is not provided with the magnet-insertion holes 11. Each of the magnet-insertion holes 11 provided in the endplate 9 is disposed opposite to each of the magnet-insertion holes 6 with the permanent magnets 7 provided therein, as shown in FIG. 2.

As the end plate 9 is provided with the magnet-insertion holes 11, the rotor core 2, together with the end plates 9, 10, can be fitted onto the rotating shaft 3 by shrinkage fit, and the permanent magnet 7 that has already been magnetized can be inserted into each of the magnet-insertion holes 6 of the rotor core 2 via each of the magnet-insertion holes 11 of the end plate 9.

Accordingly, the magnetic steel sheets are firmly secured by the end plates 9, 10, so that it is possible to prevent the magnetic steel sheets laminated with each other in the axial direction of the rotor core 2 in order to make up the rotor core 2 from coming apart, thereby facilitating insertion of the permanent magnet 7 into each of the magnet-insertion hole 6.

Further, the end plates 9, 10 each are preferably made of a non-magnetic metal. With the use of the end plates 9, made of the non-magnetic metal, respectively, an amount of magnetic fluxes of the permanent magnet 7 to be shorted via the respective end plates 9, 10 will be reduced as compared with the case of the end plates made of a magnetic metal, so that reduction in the amount of effective magnetic fluxes can be prevented.

Further, as shown in FIG. 2, with the present embodiment, each of the magnet-insertion holes 11 provided in the endplate 9 is filled up with a non-magnetic material 12 after the permanent magnet 7 is inserted therein, and further, each of the magnet-insertion holes 11, filled up with a non-magnetic material 12, is covered with a closing plate 13.

By so doing, when the permanent magnet 7 is broken, broken pieces of the permanent magnet 7 can be prevented from flying out of the magnet-insertion hole 11, so that long-term reliability can be provided.

Further, the non-magnetic material 12 with which each of the magnet-insertion holes 11 provided in the end plate 9 is filled up is preferably a resin material. This is because the resin material is inexpensive, and is easily worked on. Furthermore, because the resin material is lower in specific gravity than metal, centrifugal force can be lowered, so that strength of the end plate 9 can be enhanced. In FIG. 2, only one sheet of the closing plate 13 is provided, however, the closing plate 13 may be split into a plurality of sheets, and in the case where the permanent magnet 7 can be prevented from flying out of the magnet-insertion hole 11 by use of the non-magnetic material 12 with which each of the magnet-insertion holes 11 provided in the end plate 9 is filled up, the closing plate 13 need not be disposed.

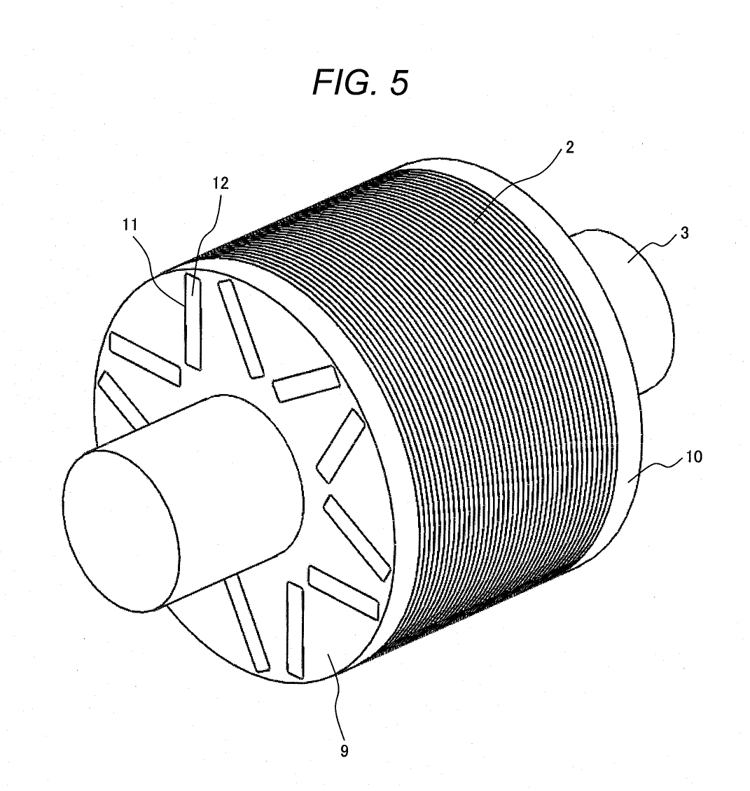

Next, there is described hereinafter a method for manufacturing the rotor 1 of the permanent magnet rotating electrical machine according to the invention with reference to FIGS. 4 to 6, respectively.

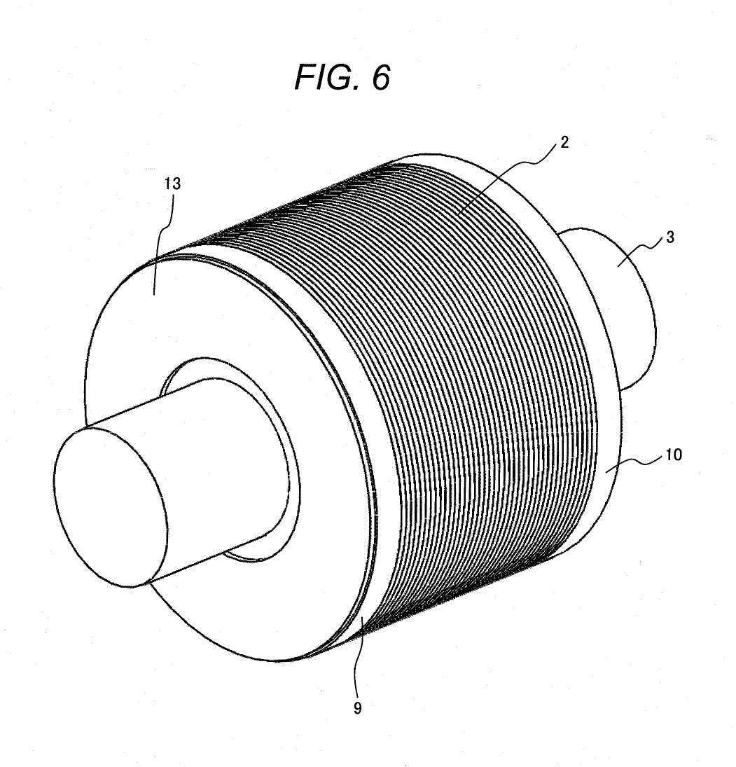

First, the rotor core 2 made up of the magnetic steel sheets laminated in the axial direction of the rotating shaft 3, together with the end plates 9, 10, is fixedly attached to the rotating shaft 3 by fitting in shrinkage fit, or by welding, and so forth, as shown in FIG. 4. Subsequently, the magnetized permanent magnet 7 is inserted into each of the magnet-insertion holes 6 of the rotor core 2 via each of the magnet-insertion holes 11 provided in the end plate 9. At this point in time, a screw hole may be provided in the end plate 9 in order to fixedly attach an insertion jig to the end plate 9, the insertion jig being for use in insertion of the permanent magnet 7. Then, each of the magnet-insertion holes 11 provided in the end plate 9 is filled up with the non-magnetic material 12 in order to stop up each of the magnet-insertion holes 11 of the end plate 9, as shown in FIG. 5, thereby preventing the permanent magnet 7 from popping out of the magnet-insertion hole 11. In order to prevent the permanent magnet 7 from popping out of the magnet-insertion hole 11 by the agency of electromagnetic force at this point in time, the permanent magnet 7 is preferably secured with the use of a jig, and so forth. Subsequently, the magnet-insertion holes 11 of the end plate 9, filled up with the non-magnetic material 12, respectively, are covered with the closing plate 13, as shown in FIG. 6. The closing plate 13 is fixedly attached to the end plate 9 by screwing, or by use of shrinkage fit. A screw hole for use in fixedly attaching the closing plate 13 to the end plate 9 may be identical to the screw hole provided in the end plate 9 in order to fixedly attach the insertion jig thereto.

With the present embodiment, as for a layout of the permanent magnets 7, there is adopted a V-shaped layout whereby two pieces of flat-plate magnets are disposed within one magnetic pole such that the opener to the outside diameter of the rotor 1 respective ends of the flat plate magnets are, the further away in distance from each other are the respective ends of the flat plate magnets, however, the number of the permanent magnets is not limited thereto, and there may be adopted other magnet layouts including a straight-line shaped layout (in a flat-plate-like state), a pair of the permanent magnets formed in a shape resembling an inverted letter V, as seen in cross section, such that the closer to the outside diameter of the rotor 1 respective ends of the flat plate magnets are, the closer in distance to each other are the respective ends of the flat plate magnets, and so forth, or use may be made of a permanent magnet formed in the shape of an arc, as seen in cross section. Further, as for the number of magnetic poles of the rotor 1, six magnetic poles are provided, however, needless to say, the invention can be similarly carried out even with the number of magnetic poles, other than that. Furthermore, the respective coils fitted in the stator are applied by distributed winding, and lap winding, however, a similar advantageous effect can be obtained by use of other winding method.

### Second Embodiment

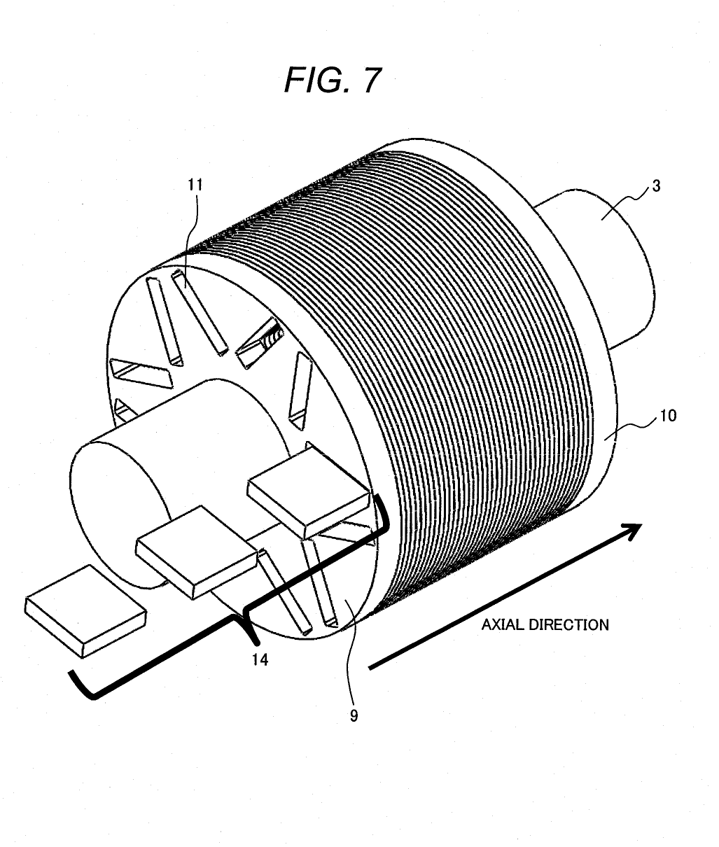

With the first embodiment described as above, there is described an example in which the permanent magnet is one body. However, for the permanent magnets to be inserted into the rotor core 2, use may be made of permanent magnets 14 formed by splitting the permanent magnet into a plurality of pieces, in the axial direction of the rotor core 2, as shown in FIG. 7.

Splitting of a permanent magnet enables dimensions of each of split permanent magnets to be reduced, so that it becomes easier to manufacture the permanent magnet. Further, the splitting renders it possible to reduce eddy current occurring to the permanent magnets at the time of operation, so that eddy-current loss as well can be reduced, thereby rendering it possible to achieve high efficiency, and reduction in magnet temperature.

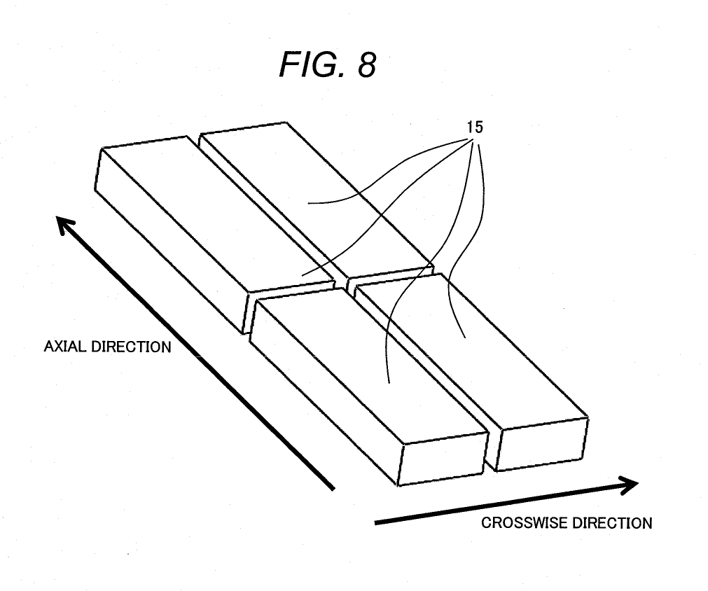

In FIG. 7, the permanent magnet is split into the plurality of pieces, in the axial direction of the rotor core 2, however, even if the permanent magnet is split into a plurality of pieces, in the crosswise direction of the rotor core 2, to form permanent magnets 15, as shown in FIG. 8, a similar advantageous effect can be obtained. Further, permanent magnets that are obtained by splitting the permanent magnet in both the axial, and crosswise directions of the rotor core 2 may be joined with each other to be inserted at a time. By so doing, an increase in man-hour of magnet insertion can be minimized. In FIGS. 7, and 8, the magnet is split into three, or four pieces, however, it goes without saying that with any other number of split pieces of the magnet, a similar advantageous effect can be obtained.

### Third Embodiment

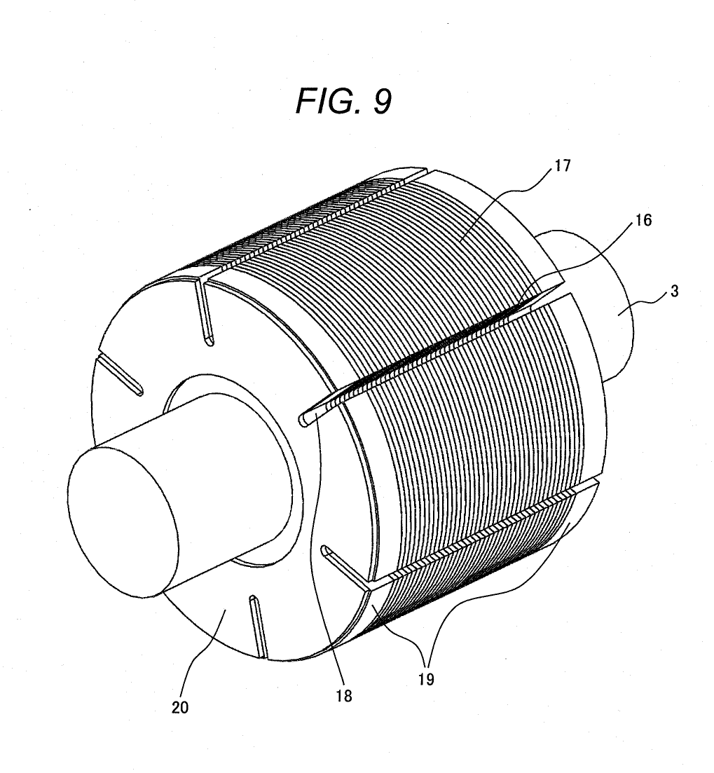

FIG. 9 shows a permanent magnet rotating electrical machine according to a third embodiment of the invention. With the present embodiment, for a rotor core, use is made of a rotor core 17 formed by laminating magnetic steel sheets, each thereof being provided with grooves 16, as shown in FIG. 9. An end plate 19, and a closing plate 20 each may be provided with grooves 18 aligned with the respective grooves 16 provided in the rotor core 17. If the rotor core 17 is provided with the grooves 16, this will enable a cooling area of a rotor to be increased, and stress as well as loss to be reduced. Further, if similar grooves are provided in the end plate 19, the grooves each will serve as a ventilation path, so that the rotor can be effectively cooled.

In FIG. 9, a position of each of the grooves provided in the rotor core 17, the end plate 19, and the closing plate 20, respectively, is located between the magnetic poles of the rotor, however, the position of each of the grooves may be located at the center of the magnetic pole, or the grooves may be located asymmetrically with respect to the center of the magnetic pole.

### Fourth Embodiment

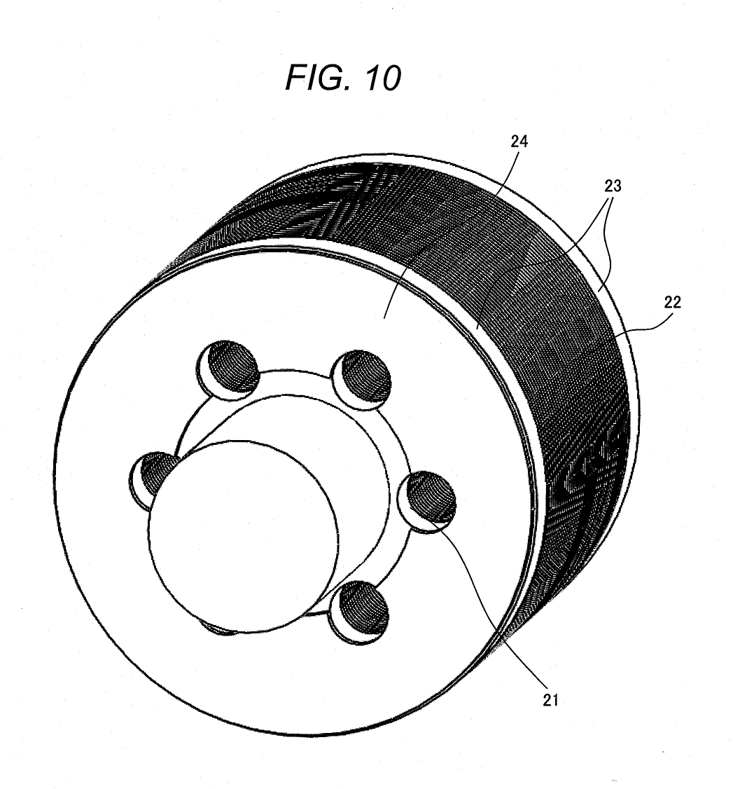

FIG. 10 shows a fourth embodiment of a permanent magnet rotating electrical machine according to the invention. With the present embodiment, for a rotor core, use is made of a rotor core 22 formed by laminating magnetic steel sheets with a plurality of holes 21 extending in the axial direction of the rotor core 22, provided therein, respectively, the plurality of holes 21 being provided at predetermined intervals, in the circumferential direction of the rotor core 22, as shown in FIG. 10. A face on one side of the rotor core 22, in the axial direction thereof, is covered with an end plate 23, and a closing plate 24, the end plate 23, and the closing plate 24 each being provided with holes formed at respective positions opposite to the holes 21 of the rotor core 22.

If the holes 21 are provided in the rotor core 22, as is the case with the present embodiment, this will render it possible to reduce mass of a rotor, and further, if similar holes are provided in each of the end plates 23, and the closing plate 24, respectively, this will permit a cooling wind to pass through the rotor via these holes, so that the rotor can be effectively cooled.

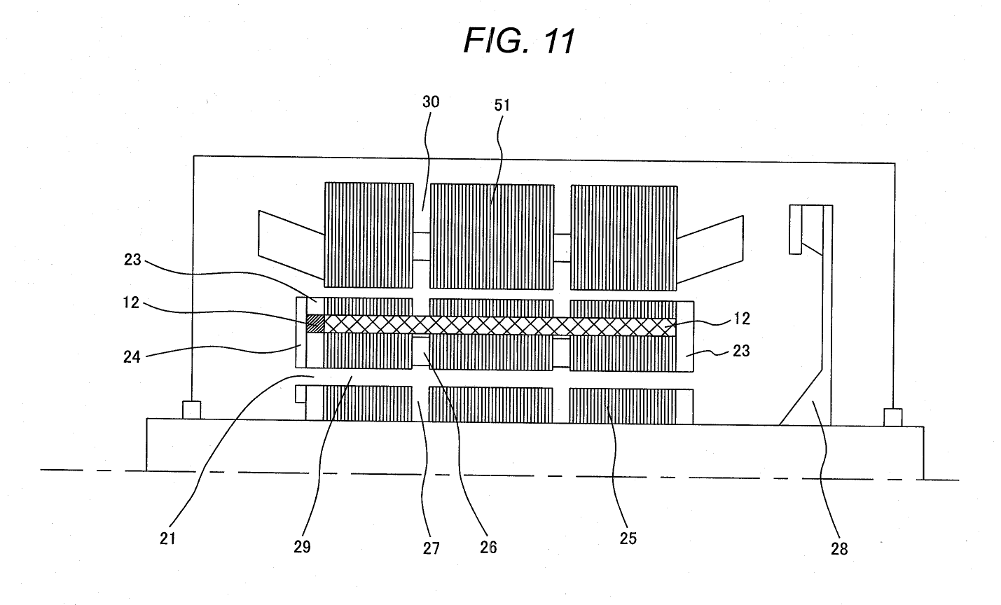

FIG. 11 shows the permanent magnet rotating electrical machine in section, in the axial direction thereof. With the permanent magnet rotating electrical machine according to the present embodiment, shown in FIG. 11, each of empty spaces (duct spaces 27, duct spaces 30) formed by each of duct pieces 26, disposed between laminated rotor cores 25, and between laminated stator cores 51, respectively, can serve as a radial duct for draft cooling, and a cooling wind sent out from a fan 28 is allowed to move from an axial duct 29 to reach each of the duct spaces 30 via the duct space 27. As a result, the rotating electrical machine in whole can be effectively cooled.

Thus, even though the permanent magnet rotating electrical machine according the fourth embodiment includes the axial duct 29, and the duct space 27, the same advantageous effect as described in the first to third embodiments, respectively, can be expected.

Further, in FIG. 11, the number of the duct pieces provided in the axial directions of the permanent magnet type rotor core and the stator core, respectively, is depicted as two lengths, however, the number of the duct pieces is not limited thereto. Further, in the figure, the duct pieces 26 are disposed in both the permanent magnet type rotor core, and the stator core, however, the duct pieces may be disposed in only the stator core. Furthermore, the duct spaces 27 may be disposed at intervals asymmetrical with respect to the center of a rotor core 25, in the axial direction thereof.

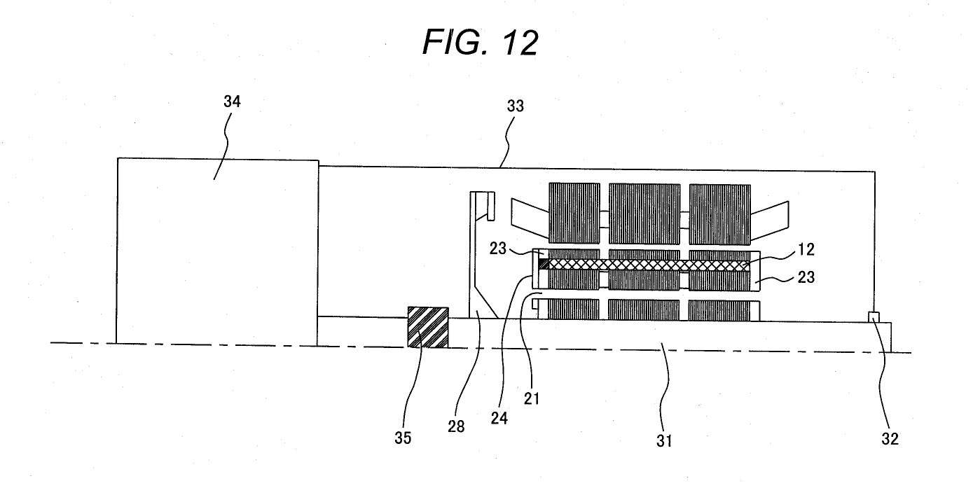

Further, use may be made of a permanent magnet rotating electrical machine 33 of a cantilevered structure, in which a bearing 32 for supporting a rotating shaft 31 is provided only at one spot, as shown in FIG. 12. In this case, even though the bearing 32 is provided only on one side of the permanent magnet rotating electrical machine 33, it is possible to prevent a rotor from coming into contact with a stator by connecting the permanent magnet rotating electrical machine 33 to an engine 34 through the intermediary of a coupling 35, and further, the number of the bearings 32 can be reduced, so that reduction in both cost, and mass can be realized.

### Fifth Embodiment

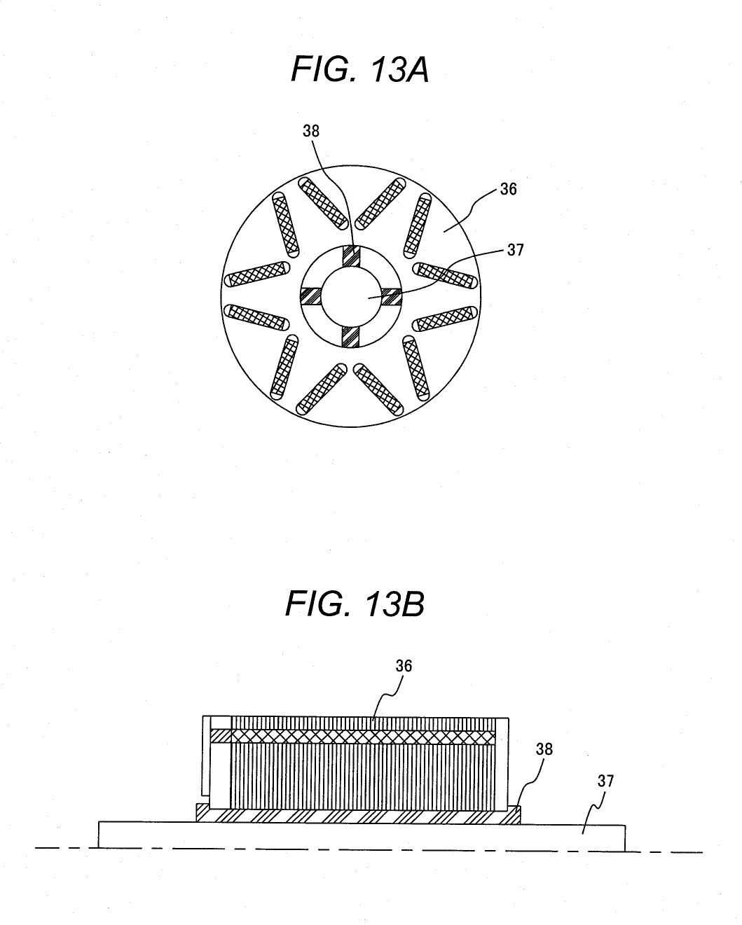

FIGS. 13A, 13B each show a fifth embodiment of a permanent magnet rotating electrical machine according to the invention. With the present embodiment, a shaft arm 38 is provided between a rotor core 36, and a rotating shaft 37, as shown in FIGS. 13A, 13B.

By providing the shaft arms 38 between the rotor core 36, and the rotating shaft 37, as is the case with the present embodiment, it is not only possible to secure strength equivalent to that in the case where the shaft arm 38 is not in use, but also possible to scale down the outside diameter of the rotating shaft 37, so that mass of the permanent magnet rotating electrical machine in whole can be reduced. With the present embodiment, the number of the shaft arms 38 is depicted as four lengths, however, the invention is not limited thereto in respect of the number of the shaft arms 38.

### Sixth Embodiment

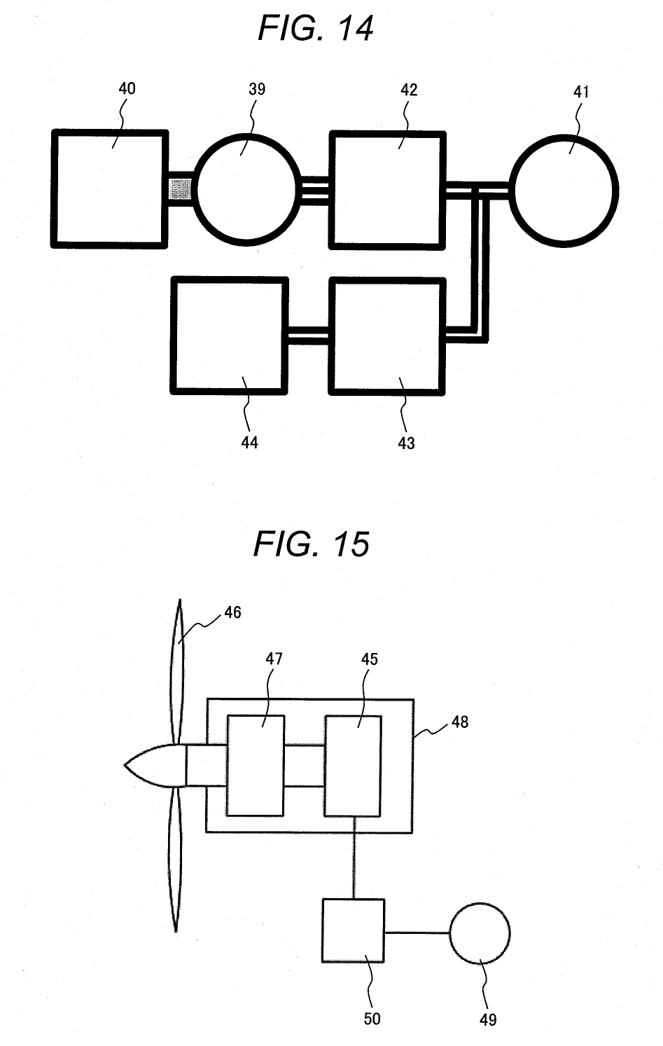

FIG. 14 shows an example in which the permanent magnet rotating electrical machine according to the invention is applied to a hybrid-drive rail car system.

As shown in FIG. 14, with the hybrid-drive rail car system, the permanent magnet rotating electrical machine 39 according to any of the first to fifth embodiments of the invention is directly connected to an engine 40, and installed in a power car of a train. Further, the permanent magnet rotating electrical machine 39 is connected to an electric power system 41 via an electric power converter 42, thereby enabling an operation for power generation to be executed. Still further, a battery 44 is connected between the electric power system 41, and the power converter 42 through the intermediary of a battery chopper 43.

The permanent magnet rotating electrical machine according to the invention has long-term reliability, and therefore, in the case of the hybrid-drive rail car system that have adopted the same, a rail car system as a whole can have a longer service life.

Further, it is also possible to provide a hybrid-drive rail car system capable of operating the permanent magnet rotating electrical machine 39 by use of the engine 40 without the battery chopper 43, and the battery 44, for the purpose of hybrid-driving, mounted therein, while operating by supplying the electric power system 41 with power generated by the permanent magnet rotating electrical machine 39.

### Seventh Embodiment

FIG. 15 shows an example in which the permanent magnet rotating electrical machine according to the invention is applied to a wind turbine system.

As shown in FIG. 15, with the wind turbine system, the permanent magnet rotating electrical machine 45 according to any of the first to sixth embodiments of the invention is connected to a wind turbine 46 via a step-up gear 47, and installed in a wind turbine nacelle 48. Further, the permanent magnet rotating electrical machine 45 is connected to an electric power system 49 via an electric power converter 50, thereby enabling an operation for power generation to be executed. The wind turbine 46 can be directly connected to the permanent magnet rotating electrical machine 45.

The permanent magnet rotating electrical machine according to the invention has long-term reliability, and therefore, in the case of the wind turbine system that has adopted the same, a wind system as a whole can have a longer service life. With the present embodiment, wind force is used as a power source, however, the invention is satisfactorily able to cope with the case of using, for example, a waterwheel, an engine, a turbine, and so forth as a power source.

What is claimed is:

1. A permanent magnet rotating electrical machine comprising:
a stator provided with a stator coil applied in a plurality of slots provided in a stator core, respectively; and
a rotor disposed opposite to the stator with a predetermined gap interposed therebetween, the rotor including a permanent magnet embedded in each of magnet-insertion holes provided in a rotor core of the rotor while polarity of the permanent magnet being varied on a pole-by-pole basis, and end plates disposed at ends of the rotor core, in the axial direction thereof, respectively,
wherein one end plate of the end plates disposed at the ends of the rotor core, in the axial direction thereof, respectively, is provided with magnet-insertion holes, and each of the magnet-insertion holes provided in the one end plate is filled up with a non-magnetic material, thereby stopping up the magnet-insertion holes.

2. The permanent magnet rotating electrical machine according to claim 1,
wherein at least the magnet-insertion holes of the one end plate, each of the magnet-insertion holes being filled up with the non-magnetic material, is covered with a closing plate.

3. The permanent magnet rotating electrical machine according to claim 1,
wherein each of the magnet-insertion holes provided in the rotor core is opposed to each of the magnet-insertion holes provided in the one end plate.

4. The permanent magnet rotating electrical machine according to claim 1,
wherein the non-magnetic material for use in filling up each of the magnet-insertion holes provided in the one end plate is a resin material.

5. The permanent magnet rotating electrical machine according to claim 1,
wherein the one end plate is formed of a non-magnetic material.

6. The permanent magnet rotating electrical machine according to claim 2,
wherein the closing plate is formed of a metal.

7. The permanent magnet rotating electrical machine according to claim 1,
wherein the permanent magnet is split in the axial direction of the rotor core, the crosswise direction thereof, or in the crosswise direction as well as the axial direction of the rotor core.

8. The permanent magnet rotating electrical machine according to claim 2,
wherein a groove is provided between the magnetic poles in the rotor core, the end plate, and the closing plate, respectively.

9. The permanent magnet rotating electrical machine according to claim 2,
wherein a groove is provided at the center of the magnetic pole in the rotor core, the end plate, and the closing plate, respectively.

10. The permanent magnet rotating electrical machine according to claim 9,
wherein the groove provided in the rotor core, the end plate, and the closing plate, respectively, is asymmetrical with respect to the center of the magnetic pole.

11. The permanent magnet rotating electrical machine according to claim 2,
wherein a hole is provided in the rotor core, the end plate, and the closing plate, respectively, the hole being provided on the inside of the magnet-insertion hole in a radial direction of the rotor core.

12. The permanent magnet rotating electrical machine according to claim 1,
wherein the rotor core is provided with a plurality of holes extending in the axial direction thereof, the plurality of holes being provided at predetermined intervals, in the circumferential direction thereof, and a face on one side of the rotor core, in the axial direction thereof, is covered with an end plate, and a closing plate, the end plate, and the closing plate each being provided with holes formed at positions opposite to the holes of the rotor core, respectively.

13. The permanent magnet rotating electrical machine according to claim 1,
wherein each of empty spaces formed by each of duct pieces disposed between laminated rotor cores, and between laminated stator cores, respectively, serves as a radial duct for draft cooling,

14. The permanent magnet rotating electrical machine according to claim 1,
wherein a shaft arm is provided between the rotor core, and a rotating shaft.

15. The permanent magnet rotating electrical machine according to claim 1,
wherein a cantilevered structure is adopted in which a bearing for supporting a rotating shaft is provided only on one side of the permanent magnet rotating electrical machine, opposite from a side thereof, adjacent to an engine to be connected thereto through the intermediary of a coupling.

16. A hybrid-drive rail car system comprising:
an engine;
a rotating electrical machine connected to the engine;
an electric power system connected to the rotating electrical machine via an electric power converter; and
a battery connected between the electric power system, and the power converter,
wherein the rotating electrical machine is the permanent magnet rotating electrical machine according to claim 1 of the invention.

17. A rail car system comprising:
an engine;
a rotating electrical machine connected to the engine; and
an electric power converter connected between the rotating electrical machine and an electric power system,
wherein the rotating electrical machine is the permanent magnet rotating electrical machine according to claim 1 of the invention.

18. A wind turbine generator system comprising:
a wind turbine;
a rotating electrical machine connected to the wind turbine;
a nacelle for housing the rotating electrical machine therein; and
an electric power converter connected between the rotating electrical machine, and an electric power system,
wherein the rotating electrical machine is the permanent magnet rotating electrical machine according to claim 1 of the invention.

19. A method for manufacturing a rotor of a permanent magnet rotating electrical machine, comprising the steps of:
laminating a plurality of magnetic steel sheets, in the axial direction of the rotor, thereby forming a rotor core with magnet-insertion holes provided therein;
disposing one end plate with magnet-insertion holes formed therein, at one end of the rotor core, in the axial direction thereof while disposing the other end plate without the magnet-insertion hole formed therein, at the other end of the rotor core, in the axial direction thereof;
inserting a magnetized permanent magnet into each of the magnet-insertion holes of the rotor core via each of the magnet-insertion holes provided in the end plate after fixedly attaching the rotor core, and both of the endplates to a rotating shaft; and
filling up each of the magnet-insertion holes provided in the end plate with a non-magnetic material after the magnetized permanent magnet is inserted, thereby stopping up each of the magnet-insertion holes provided in the end plate.

20. The method for manufacturing a rotor of a permanent magnet rotating electrical machine, according to claim 19, further comprising the step of covering the magnet-insertion holes provided in the endplate with a closing plate after filling up each of the magnet-insertion holes provided in the end plate with the non-magnetic material.
